(19) United States
(12) Patent Application Publication
(10) Pub. No.: US 2018/0213220 A1
(43) Pub. Date: Jul. 26, 2018

(54) CAMERA TESTING APPARATUS AND METHOD

(71) Applicant: Ferrand D.E. Corley, Mississauga (CA)

(72) Inventor: Ferrand D.E. Corley, Mississauga (CA)

(21) Appl. No.: 15/867,875

(22) Filed: Jan. 11, 2018

Related U.S. Application Data
(60) Provisional application No. 62/448,670, filed on Jan. 20, 2017.

(51) Int. Cl. H04N 17/00; H04N 17/02; H04N 5/225

(52) U.S. Cl. CPC H04N 17/002; H04N 5/2256; H04N 17/02

(57) ABSTRACT

The invention is an apparatus designed to solve problems in camera evaluation, namely the selection of camera equipment based on tests that are different to the real world conditions under which the cameras will be used. This is a significant problem, particularly in law enforcement, security and medical imaging. Also disclosed is a method of comparing the performance of two or more movie cameras, under identical simulated real world conditions.

This application is based on U.S. Provisional application Ser. No. 62/448,670 Title: CAMERA TESTING APPARATUS AND METHOD filed Jan. 20, 2017, the priority of which is claimed.

### FIELD OF THE INVENTION

The invention is designed to solve problems in camera evaluation, namely the selection of camera equipment based on tests under conditions that are different to the conditions under which the cameras will be used. This is a significant problem, particularly in law enforcement, security and medical imaging.

The invetion comprises an apparatus that enables the testing and comparison of moving or still images from multiple cameras, the cameras recording identical two and three dimensional moving reference test targets. Cameras to be tested and compared are placed on a support mechanism that enables one or more cameras to be aligned to the same field of view. Two or more cameras can be tested sequentially or, using beam splitting technology, well known in the trade, simultaneously in groups of one to three cameras. A second support mechanism comprising pre-programmed components, enables two and three dimensional reference test targets to be moved at varying speeds within the cameras' field of view. The reference test targets include life-size or scaled down 3-D reference test targets/human replica, along with test patterns incorporating color, resolution, dynamic range, framing elements as known in the trade. To illuminate the test targets under real-world conditions, multiple light sources positioned within or adjacent to the apparatus, provide illumination having color and brightness characteristics designed to match the brightness and spectral characteristics of typical real-world light sources, sunlight, incandescent, fluorescent, LED for example. To maintain the same lighting angle multiple illuminants having different spectral or brightness characteristics, should emanate from the same housing.

### BACKGROUND OF THE INVENTION

As long as man has been reproducing visual images on cave walls, the reproductions have fallen into two categories, accurate reproduction of a scene, or enhanced reproduction of the scene to produce a more pleasing image.

The identical situation exists in modern photography; precision reproduction of an image for accurate identification, or artistic enhancement and intentional distortion for visual effect.

Accurate image reproduction is particularly important in law enforcement and medical imaging where the accuracy of reproduction can mean the difference between life and death.

While today's digital imaging technology provides greater potential for accurate image reproduction, film based photography of the last century benefitted from a more stable image recording system, because cameras all used essentially the same image recording media and technology. Additionally, whereas previous illuminants, essentially sunlight or tungsten, were full spectrum light sources, today's illuminants such as LED and fluorescent, have discontinuous energy spectrums.

Digital imaging in different cameras not only uses different types of image sensing technology, CCD and CMOS for example, but there are variations within those systems such as sCMOS. This along with variability in the characteristics of the light sources illuminating a scene can result in significant differences in the images produced by such cameras.

While technology exists to test multiple cameras by recording the same test image in each camera and comparing results, cameras perform very differently one to another in real world conditions, particularly when photographing moving images.

The invention provides robotic test targets as identical moving objects, in this embodiment being shown as replicas of a human being, along with other reference images. By photographing an identical sequence of movements, of he same robotic target, under identical lighting conditions with different movie cameras, the invention enables performance differences between such movie cameras to be identified and quantified, facilitating selection of the most suitable camera for use in a particular application. For example, security cameras used in an airport would typically be operating under similar conditions of lighting both for brightness level and spectral characteristics, whereas a police officer's body camera needs to produce accurate constantly moving images under a wide variety of conditions from bright sunshine to a dimly-lit dark alley at night.

### IN THE DRAWINGS

The invention is described by way of illustration with reference to the accompanying drawings in which:

FIG. 1—is a horizontal elevation view of the apparatus with a robotic target, in this case a human replica, shown in three positions as it approaches a camera;

FIG. 2—is a top plan view of one embodiment of the apparatus, illustrating the robotic target (human replica) shown with illumination supported on the robotic carriage, around the target;

FIG. 3—is an example of the monitor display showing the human replica some distance from the camera;

FIG. 4—is an example of the monitor display showing a close-up image of the face as the human replica approaches the camera;

FIG. 5—is an example of a monitor image from two cameras, A and B, both reproducing the test target accurately;

FIG. 6—is an example of a monitor showing differences in skin tone reproduction between cameras A and B;

FIG. 7—is an example of a monitor showing differences in shadow detail or color between cameras A and B;

FIG. 8 is a perspective of a control panel for setting the lighting conditions for a particular set of tests;

FIGS. 9, 10, 11 and 12 are graphs showing typical results of tests of four different cameras, using the invention.

### DESCRIPTION OF A SPECIFIC EMBODIMENT

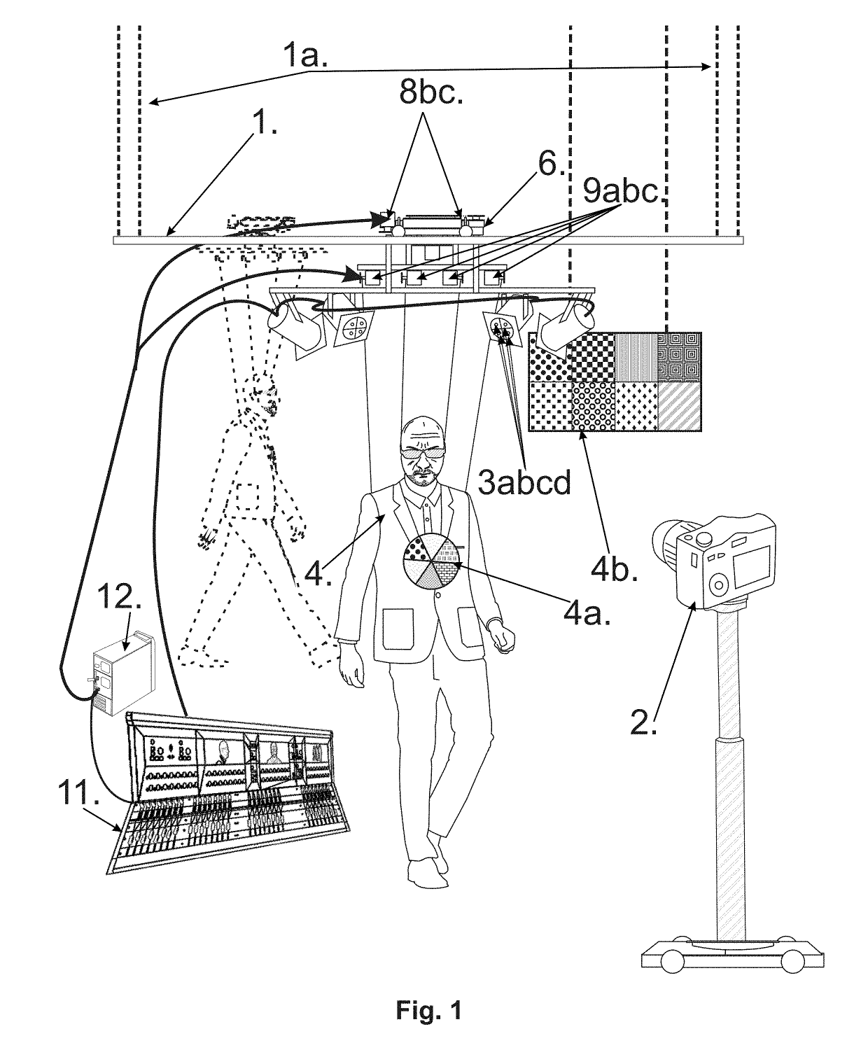

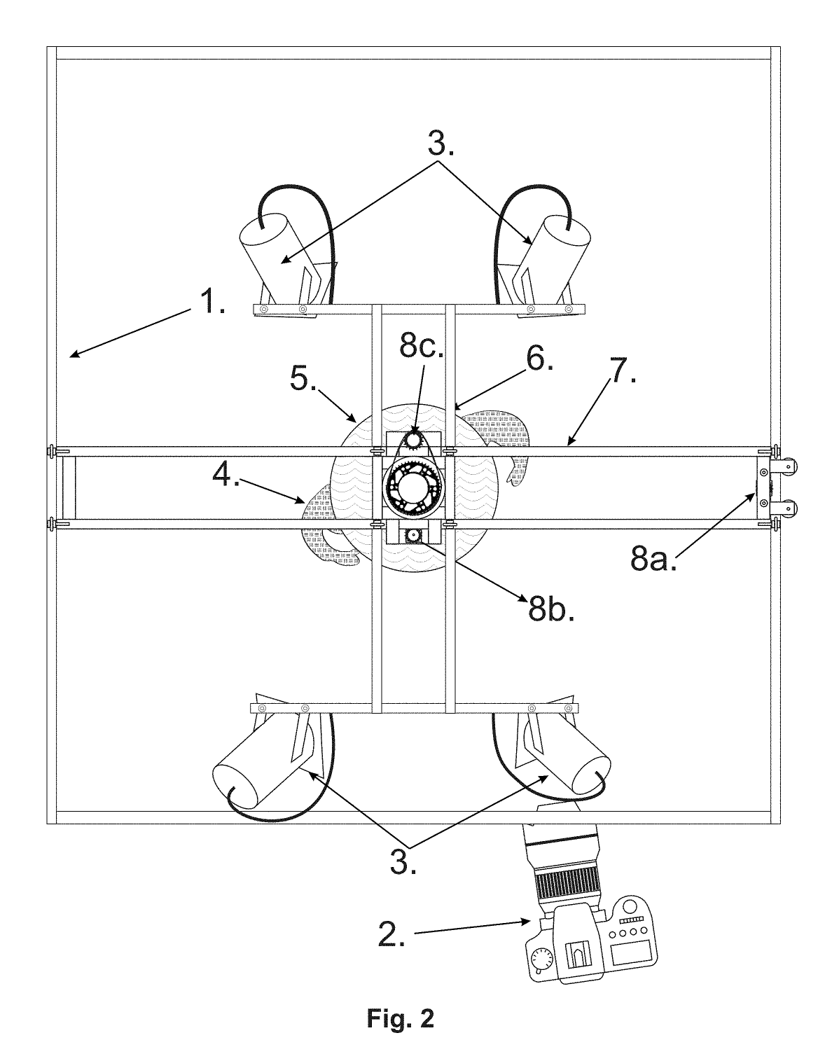

FIG. 1 shows in this embodiment, main rails (1), which is typically suspended from above on elements (1a). This will provide the camera (2) and lights (3) an unobstructed view of a target object, in this case a human replica (4), hanging from a rotatable member (5).

Member (5) is attached to a cross frame (6) which is supported by beam member (7). Beam (7) is supported at each end on rails (1).

Three primary motor drives (8a), (8b), and (8c) enable rotatable member (5) and a robotic target, which in this embodiment is shown as a human replica, and/or other test target/s (4a) hanging from the member (5).

The target will typically have some movable components, such as the arms and legs. However the target may in fact be held stationary and the camera may be moved relative to the target. This may simulate a situation such as the body camera of a police officer, for example. The motor drives (8) are operable so that the target can be moved anywhere within the confines of the main frame (1) along both x and y axes and can be rotated 360 degrees. Other stationary or moving test targets (4b) may be included within the camera's field of view.

Thus the target can be moved across the field of view or advanced or returned, or moved in a diagonal direction, or rotated, by the primary motors (8).

Secondary motors (9a) and (9b) support the left and right side of test target (4) to provide vertical control of the target (4), while motors (9c), (9d), (9e) enable movement of other target elements, such as arms, legs and the like within or attached to test target (4).

The primary (8) and secondary motors (9) are controlled by software programs to provide, in this embodiment, a lifelike motion to the target, in this case the human replica. This is accomplished in part, in this case, by the secondary motors (9), which are operable to provide a side to side movement component, and an up and down movement component as the robotic target or human replica moves forward or backward or turns.

The robotic target (4) in this case is a form of marionette, having a torso and head, and having moveable arms and legs.

Test panels (4a), typically having separate segments of different colors and grey scales, known in the art, may be attached to the test target Two or more cameras can be tested sequentially or, using beam splitting technology known in the art, simultaneously in groups of one to three cameras, if desired.

A computer (12) supplies software control signals to motors 8 and 9. The program of movements can be varied to suit the typical situation for which the cameras are to be tested. In this way the movements and sequence of movements can be preselected and set, so that successive cameras can be tested under identical movements and simulated conditions.

Lighting such as lights (3) are supported from frame (6). Preferably four such lights are provided to provide uniform preselected lighting for the target, from all four corners.

Each light (3) may have, for example, four different light sources. These sources, may be LED, and/or fluorescent, and/or daylight and/or incandescent.

A control panel (11) is provided to pre set the light condition for each set of tests. While a manual control (11) is illustrated for the sake of simplicity, it will be understood that these settings could also be provided by the computer (10).

The lights (3) are supported from the frame (6) so that as the frame (6) moves according to the movement sequence selected, the lights will travel with it.

The target is thus illuminated uniformly through each sequence of test movements.

The control panel (11) provides individual manipulation of each color, including brightness, and other light characteristics. It will be appreciated that the actual lighting in any given real life experience may vary by a factor of 10,000 on a bright sunny day, to 1 in a dark alley or cellar. By providing the variety of light sources, and the control panel (11) it is possible to set simulated conditions as close as possible to those which the cameras will be experiencing, in the field.

In order to provide exact timing for the tests a flashing LED light (not shown) provides for exact synchronisation of each test run.

The camera itself is preferably on a movable carriage, and the camera can be rotated, raised or lowered, for various views and scenes.

This system enables scenes to be photographed over a range of 24 F stops, and enables the field of view FOV of each camera to be varied from wide angle to more restricted FOV, depending on the requirements for which the camera is being specified.

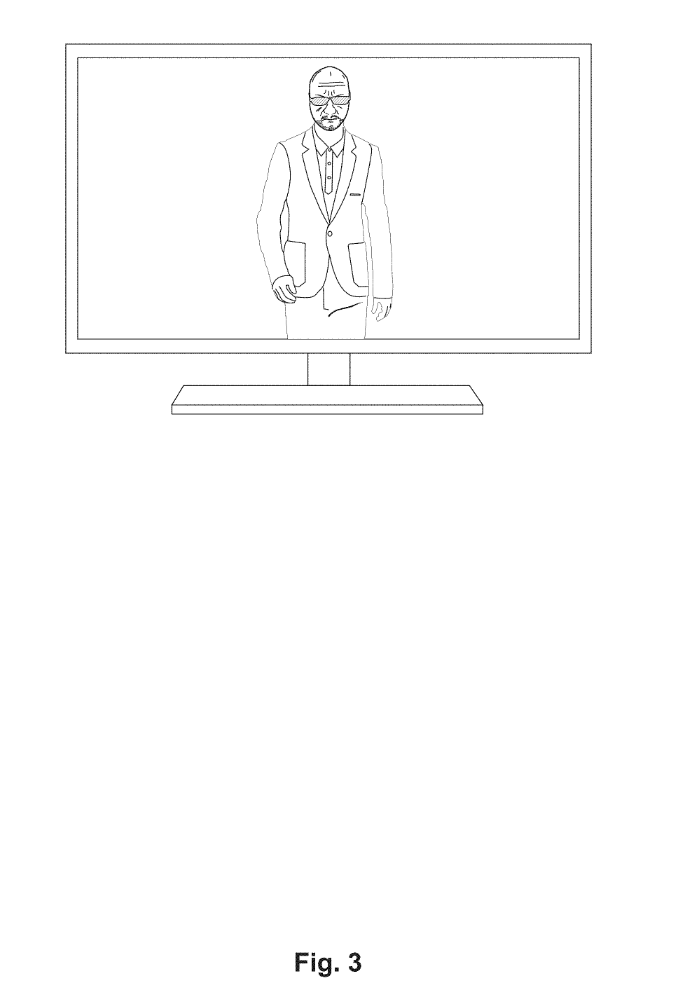

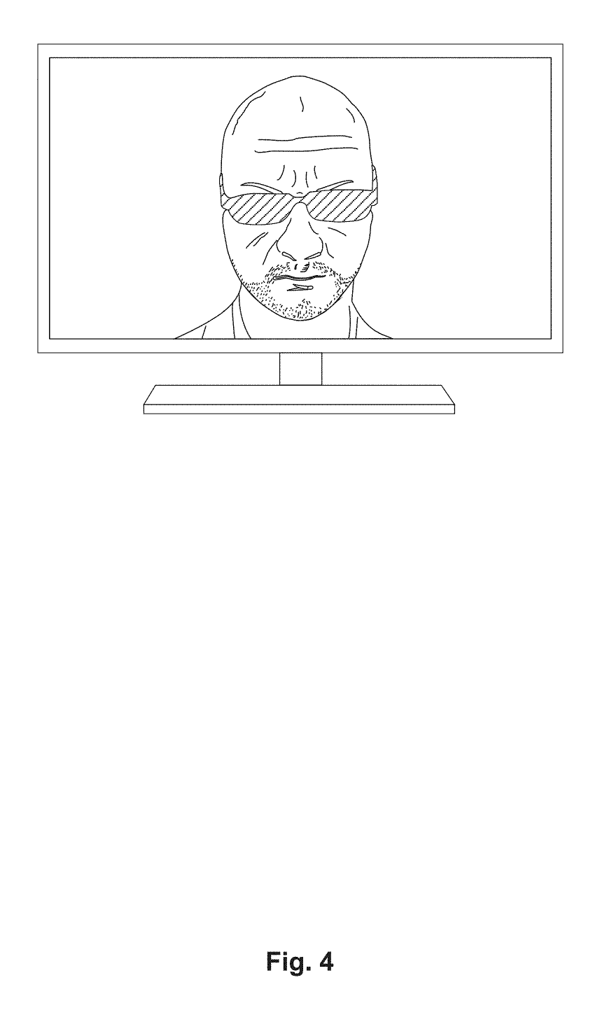

An example of the monitor display in FIG. 3 shows the human replica some distance from the camera, and a close-up image of the face is shown in FIG. 4 as the human replica approaches the camera.

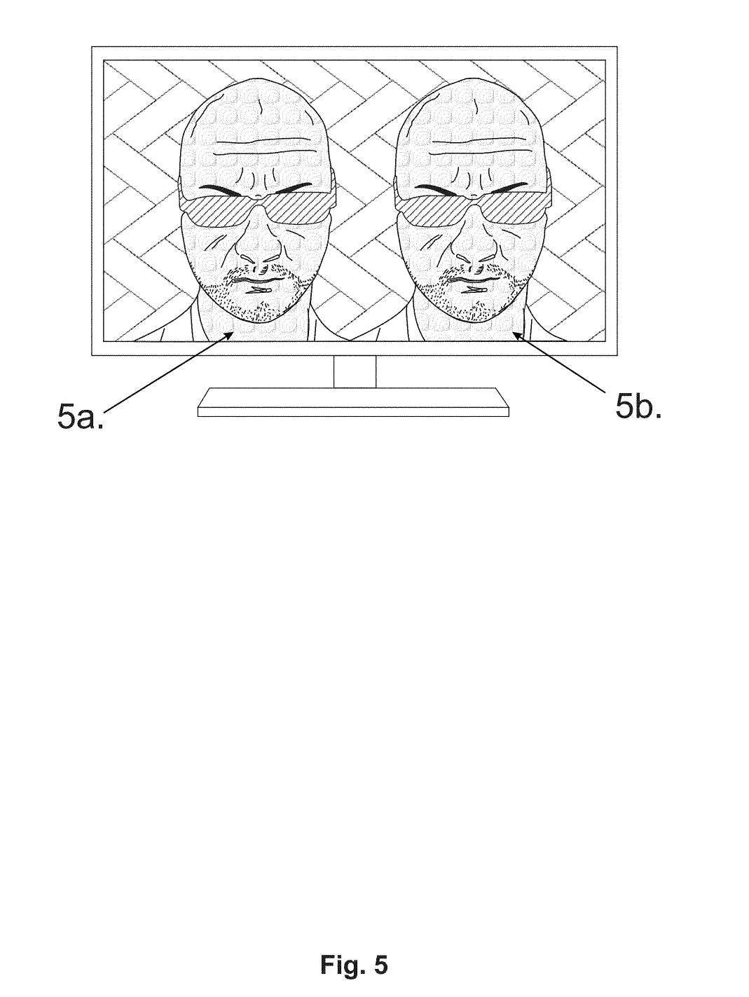

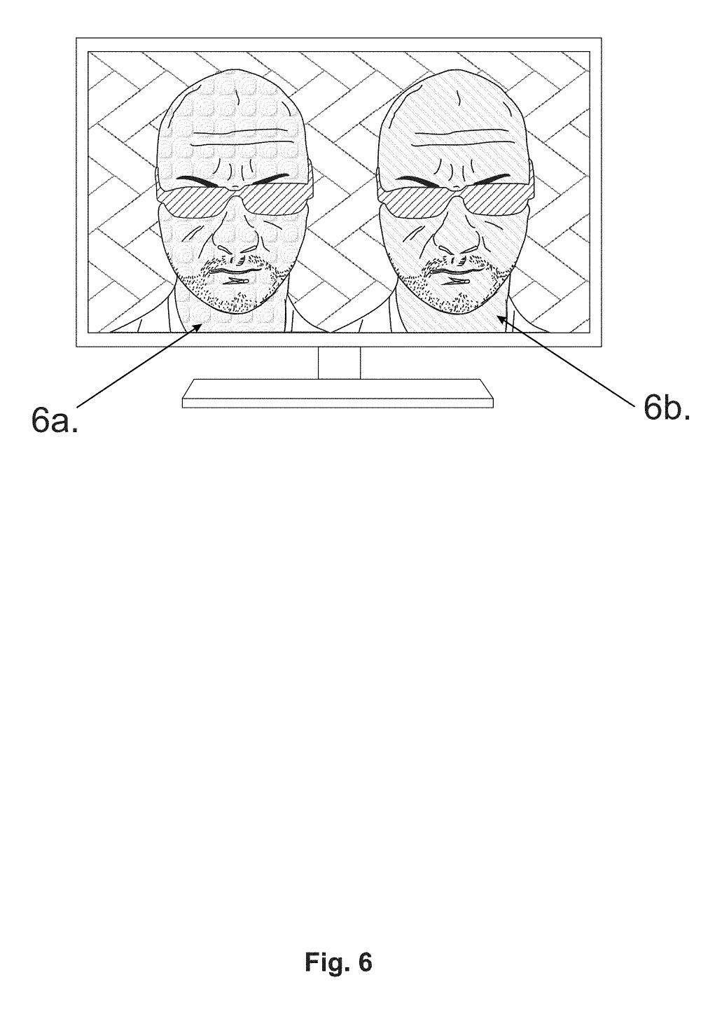

A monitor image from two cameras, A and B, is shown in FIG. 5 both cameras reproducing the test target accurately and a monitor showing differences in skin tone reproduction between cameras A and B is shown in FIG. 6;

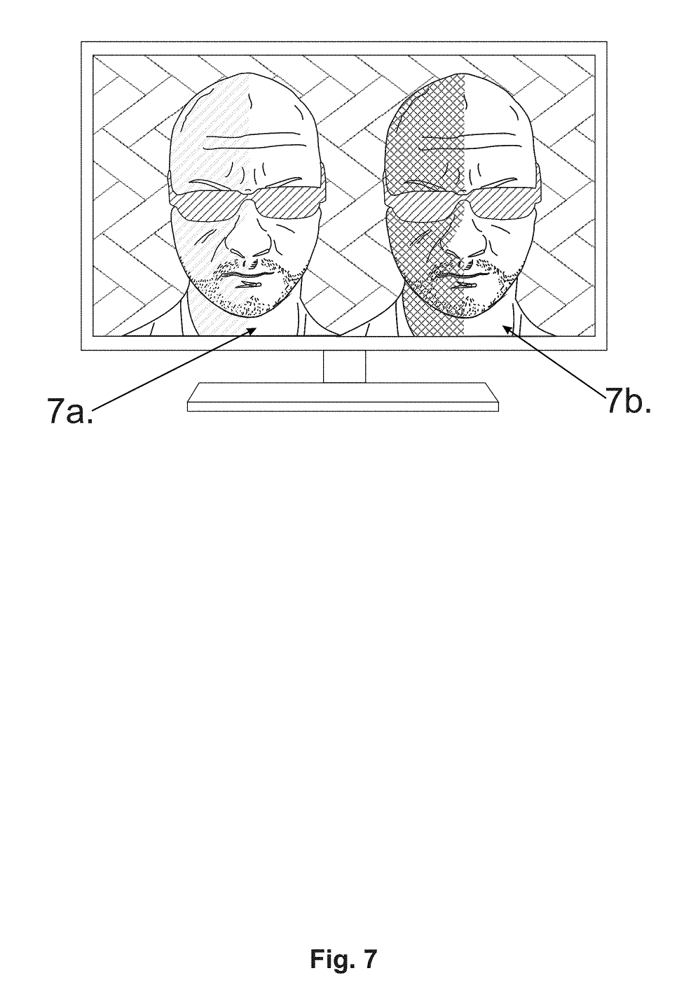

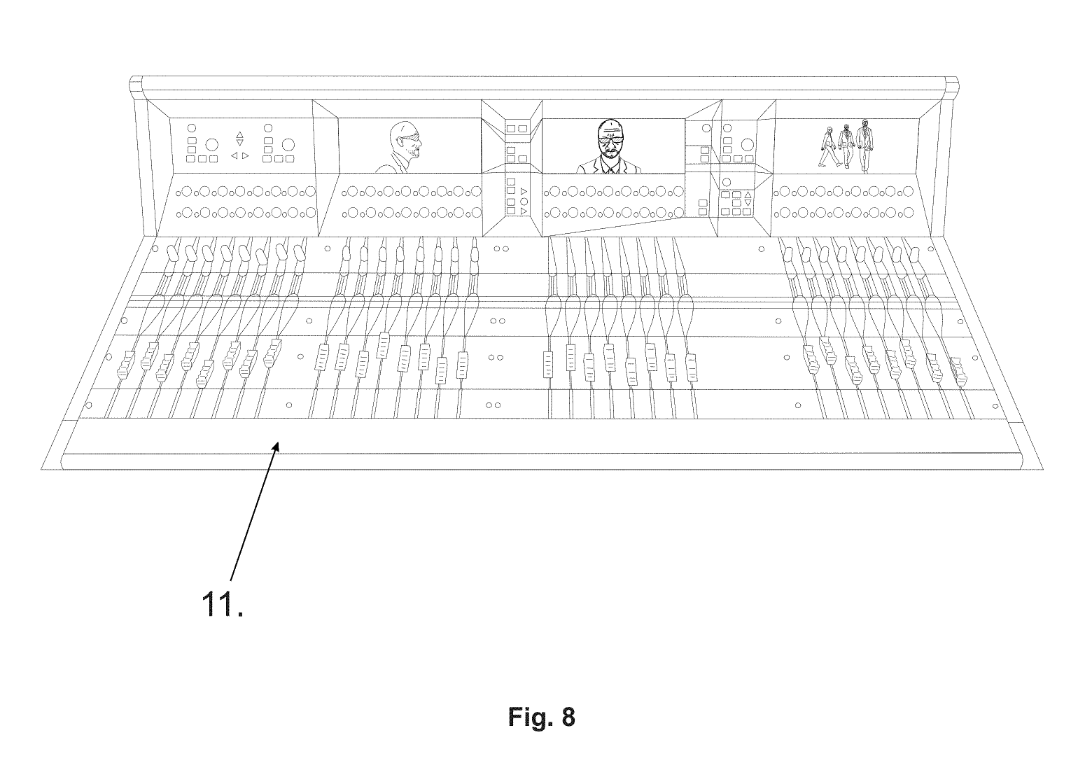

A monitor showing differences in shadow detail or color between cameras A and B is shown in FIG. 7. A control panel (11) for the lights is shown in FIG. 8.

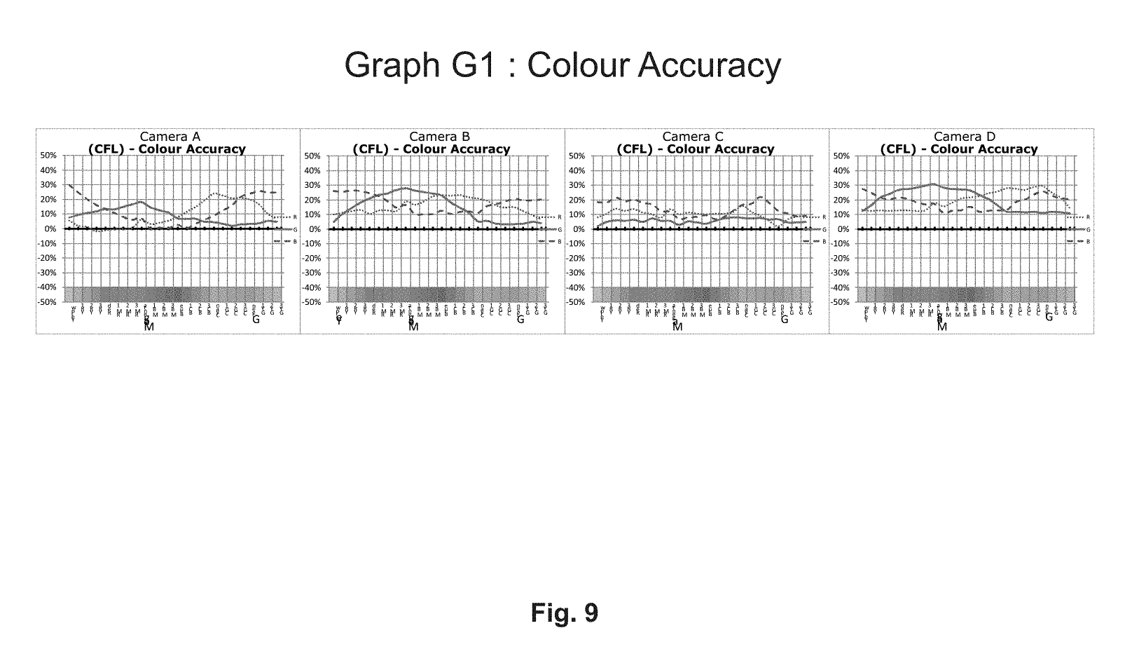

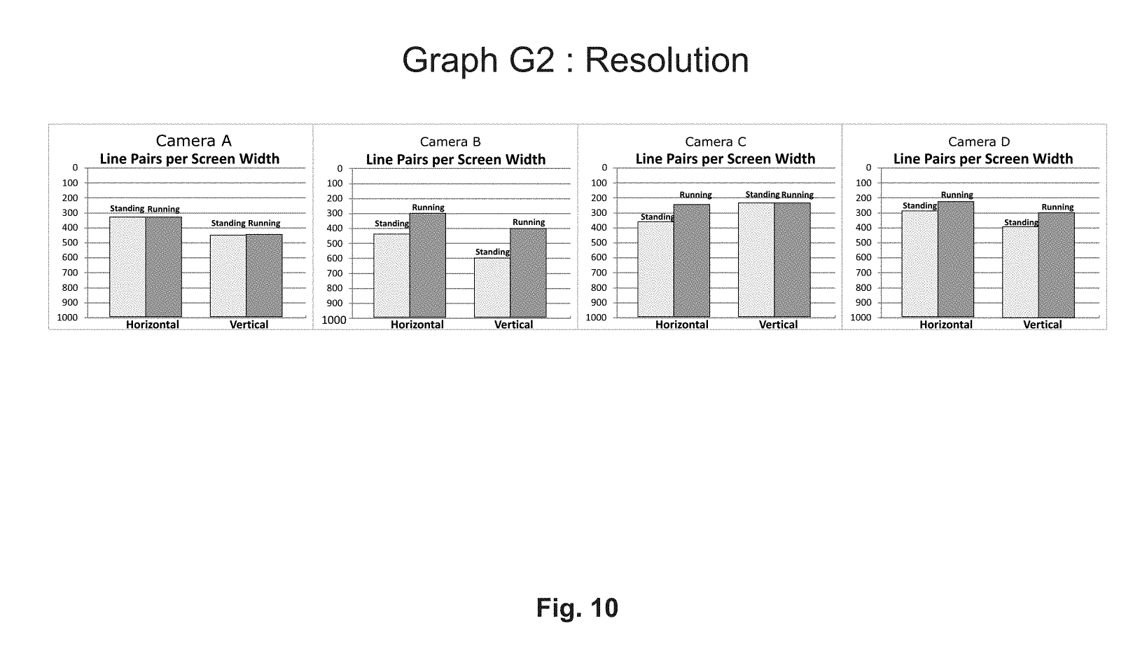

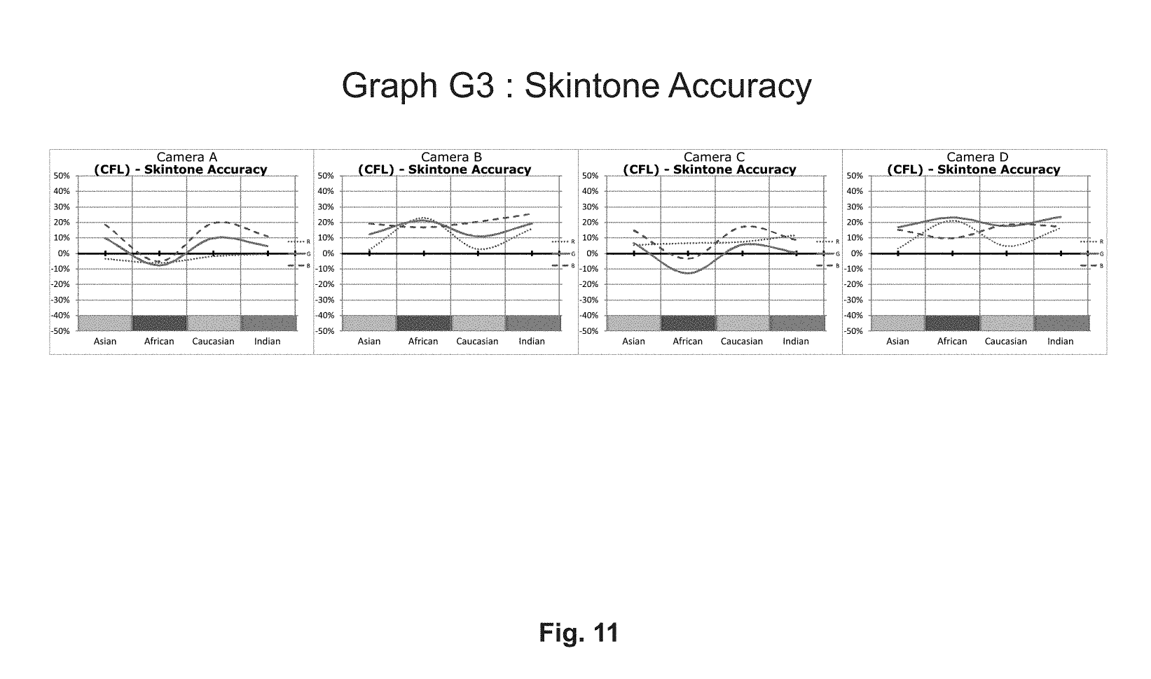

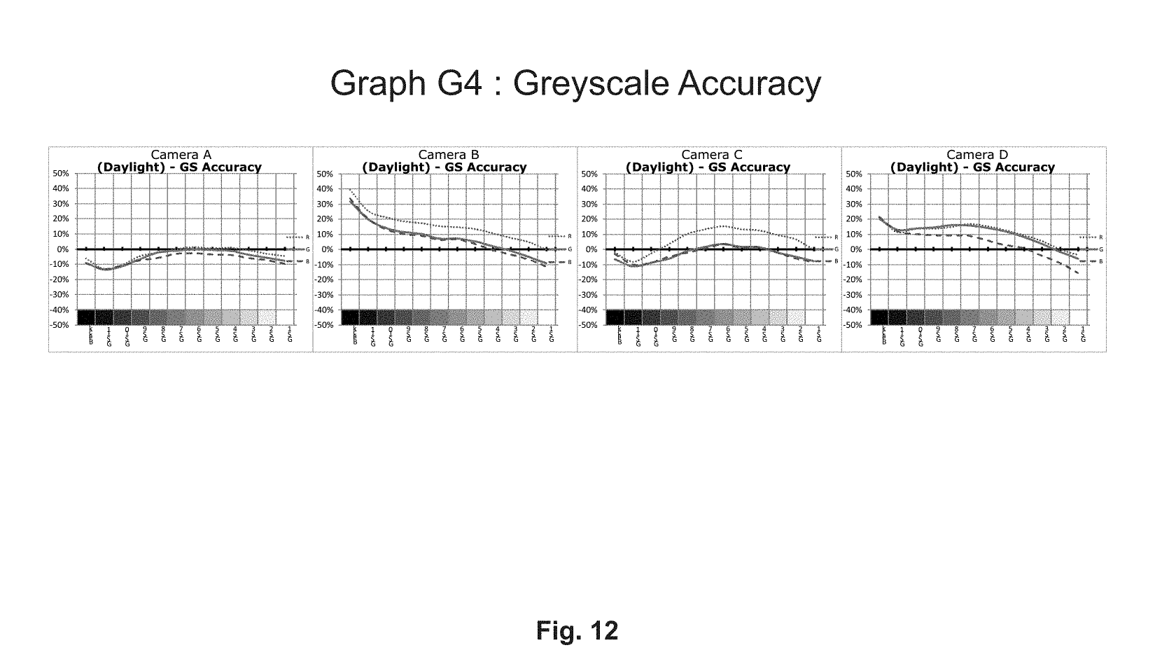

Four graphs in FIGS. 9, 10, 11 and 12 compare the important characteristics of four different cameras. In each case, the graphs show deviation from optimum performance; all signals on a perfect camera would fall on the zero line or, in the case of resolution, produce minimal sized boxes.

Graph 1—indicates the Red, Green and Blue color error errors through the visible spectrum, indicated at the bottom of the graph. Camera C performs the best, producing minimal color distortion.

Graph 2—demonstrates the horizontal and vertical resolution reproduction capability of the cameras. Primarily used for body worn cameras, the graphs show resolution from a person standing still and simulated running; camera B gives the best performance of the cameras.

Graph 3—indicates skin tone reproduction accuracy for four different ethnic skin types, Asian, African, Caucasian and Indian. It is evident from the outset camera a reproduces dark African skin tones best.

Graph 4—plots how well a camera reproduces gray tones, both from a brightness perspective and deviation from neutrality, showing the red green and blue components. It is evident that camera A reproduces dark tones darker than it should and camera B. reproduces the same tones lighter than optimum.

It should be noted that these graphs are of one light source only; there would be similar graphs for the other three light sources.

In Operation:

The basic sequence of steps of method of evaluating movie cameras would be as follows:

a. establishing an enclosed space with predetermined controllable lighting conditions;

b. operating at least one robotic object performing a predetermined sequence of movements in the enclosed space under predetermined lighting conditions;

c. recording the scene in the enclosed space of the predetermined sequence of movements of the object with a first movie camera;

d recording the same scene in the same enclosed space with the identical set of predetermined sequence of movements and identical lighting of the object with a second movie camera; and,

e. comparing scenes recorded by said first movie camera with said scenes recorded by said second movie camera.

The foregoing are descriptions of preferred embodiments of the invention which are given here by way of example only.

What is claimed is:

1. An apparatus for identifying differences in the image reproduction accuracy of cameras such as digital movie cameras by photographing and recording a sequence of movements of a three dimensional target with a first movie camera; repeating said steps with a second movie camera, and comprising;
a robotic target having at least some moveable components;
drive means for moving said robotic target moveable components through a predetermined sequence of movements;
illumination for illuminating said robotic target with a predetermined level and hue of illumination;
control means for controlling said drive means while said robotic target is viewed by at least two movie cameras; and,
control means for controlling said illumination while said robotic target is viewed by at least two movie cameras, thereby enabling a comparison of the performance as between said two cameras.

2. The apparatus for identifying differences in the image reproduction accuracy of cameras such as digital movie cameras as claimed in claim 1, where color and resolution test patterns are added to the three dimensional target.

3. The apparatus for identifying differences in the image reproduction accuracy of cameras such as digital movie cameras as claimed in claim 2, wherein said lighting includes illuminants having predetermined levels brightness, spectral distribution and specular characteristics selected from the group comprising LED, fluorescent, sodium, quartz, halide and incandescent light sources.

4. The apparatus for identifying differences in the image reproduction accuracy of cameras such as digital movie cameras as claimed in claim 3, wherein said lighting is located at spaced locations around said target, and is supported to move with said target.

5. The apparatus for identifying differences in the image reproduction accuracy of cameras such as digital movie cameras as claimed in claim 1 including a support structure for said robotic target, said support structure having a pair of parallel spaced apart support rails: at least one transverse beam movably supported on said pair of support rails; suspension elements extending downwardly from said transverse beam, and connected to said robotic target, to support said robotic target beneath said transverse beam, and movement means for moving said transverse beam along said pair of support rails.

6. The apparatus for identifying differences in the image reproduction accuracy of cameras such as digital movie cameras as claimed in claim 5 including a rotary support, supported on said transverse beam, said support elements extending downwardly from said rotary support, whereby the robotic target can be rotated about a vertical axis relative to said transverse beam.

7. The apparatus for identifying differences in the image reproduction accuracy of cameras such as digital movie cameras as claimed in claim 6 including a control motor connected to said rotary support, whereby said rotary support can be rotated.

8. The apparatus for identifying differences in the image reproduction accuracy of cameras such as digital movie cameras as claimed in claim 7 including lighting sources attached to said transverse movable beam, for illuminating said robotic target, said lighting being located at spaced apart locations, spaced around said vertical axis of said rotary support.

9. The apparatus for identifying differences in the image reproduction accuracy of cameras such as digital movie cameras as claimed in claim 8 including control means for controlling movement of said transverse beam relative to said support rails, and further control means for controlling rotation of said rotary support relative to said transverse beam.

10. The apparatus for identifying differences in the image reproduction accuracy of cameras such as digital movie cameras as claimed in claim 9 and including a movable carriage for said rotary support, whereby the same can be transported along said transverse beam, and controls for controlling movement of said rotary support.

11. The apparatus for identifying differences in the image reproduction accuracy of cameras such as digital movie cameras as claimed in claim 10, wherein each said lighting source incorporates at least four separate illuminants, and lighting control means for controlling said separate illuminants, and said lighting control means being operable to control the light intensity characteristics of said light.

12. The apparatus for identifying differences in the image reproduction accuracy of cameras such as digital movie cameras as claimed in claim 1 including a camera support carriage for supporting a said camera, and movable means for transporting said camera carriage relative to said robotic target.

13. The apparatus for identifying differences in the image reproduction accuracy of cameras such as digital movie cameras as claimed in claim 11 where said target is a human replica.

14. A method of evaluating movie cameras and comprising the steps of:
a. establishing an enclosed space with predetermined controllable lighting conditions;
b. operating at least one robotic target performing a predetermined sequence of movements in said space under predetermined lighting conditions;
c. recording the scene in said space with said predetermined lighting and sequence of movements of said target with a first movie camera;
d. recording the scene in said space with the identical lighting and identical set of predetermined sequence of movements of said target with a second said movie camera; and,
e. comparing scenes recorded by said first movie camera with said scenes recorded by said second movie camera.

15. The method of evaluating movie cameras as claimed in claim 14 and including the steps of moving said robotic target from one side of said enclosed space to another, while recording the robotic target with a first camera and then repeating said steps with a second movie camera.

16. The method of evaluating movie cameras as claimed in claim 15 including the steps of moving said robotic target towards a camera, in a predetermined sequence of movements, and recording said robotic target with a first said movie camera and then recording said robotic target with a second said movie camera while performing identical steps.

17. The method of evaluating movie cameras as claimed in claim 16 including the steps of rotating said robotic target, while transposing said robotic target in said space.

18. The method of evaluating movie cameras as claimed in claim 17 including the step of establishing predetermined lighting characteristics for said robotic target, and maintaining said predetermined lighting characteristics during movement of said robotic target as aforesaid.
